(19) United States
(12) Patent Application Publication
(10) Pub. No.: US 2026/0188804 A1
(43) Pub. Date: Jul. 2, 2026

(54) RECHARGEABLE BATTERY AND BATTERY PACK INCLUDING THE RECHARGEABLE BATTERY

(71) Applicant: SAMSUNG SDI CO., LTD., Yongin-si (KR)

(72) Inventors: Dae Kyu KIM, Yongin-si (KR); Jongjun PARK, Yongin-si (KR); Kwangsoo SEO, Yongin-si (KR); Shinjung KIM, Yongin-si (KR)

(21) Appl. No.: 19/404,183

(22) Filed: Dec. 1, 2025

(30) Foreign Application Priority Data
Jan. 2, 2025 (KR) 10-2025-0000438

(51) Int. Cl. H01M 50/152; H01M 50/159; H01M 50/16; H01M 50/342; H01M 50/578

(52) U.S. Cl. CPC H01M 50/152; H01M 50/159; H01M 50/16; H01M 50/3425; H01M 50/578

(57) ABSTRACT

A rechargeable battery according to an embodiment of the present disclosure includes a case, an electrode assembly accommodated in the case, and a cap assembly coupled to the case. The cap assembly includes a lower cap, a vent plate on the lower cap, an upper cap disposed opposite to the lower cap with the vent plate interposed therebetween, and a insulating disk including a plate adjacent to the lower cap and a leg extending from the plate toward the electrode assembly. A plurality of openings are formed in the lower cap, with the opening being positioned arranged radially around a center of the lower cap. The first insulating disk is disposed radially inward from the plurality of openings.

### CROSS-REFERENCE TO RELATED APPLICATION

This application claims priority to and the benefit of Korean Patent Application No. 10-2025-0000438 filed in the Korean Intellectual Property Office on Jan. 2, 2025, the entire contents of which are incorporated herein by reference.

### BACKGROUND OF THE DISCLOSURE

### (a) Field of the Invention

The present disclosure relates to a rechargeable battery and a battery pack including the rechargeable battery.

### (b) Description of the Related Art

Rechargeable batteries are widely used in various industries because of their high energy density and efficient design. These rechargeable batteries include a metal case that accommodates a wound electrode assembly and an electrolyte therein, and a cap assembly (current interruption device, CID) disposed on the top of the case to manage internal pressure and gas.

Electrochemical reactions occurring inside the battery during charging and discharging processes may produce heat and gas such as oxygen and hydrogen. The generation of heat and gas increases the pressure inside the case and may cause deformation of the wound electrode assembly.

The case has one end to accommodate, for example, a cap assembly. The other end of the case that faces the open end is rigidly affixed. This structural arrangement may cause the expansion force of the electrode assembly to be concentrated toward the cap assembly.

A center winding portion of the electrode assembly is the most structurally compressed portion, and the center winding portion is a part where stress accumulates due to internal gas and heat generation. This may cause the electrode assembly to expand or rise from the center winding portion toward the cap assembly.

The rising phenomenon of the electrode assembly may cause deformation of the internal structure of the rechargeable battery and may damage insulating materials such as gaskets. And such damage may lead to an electrical short between the electrodes. Additionally, a deformed electrode assembly may interfere with normal operation of the vent plate and cap assembly by blocking internal pressure relief and gas escape paths. As such, the rising phenomenon of the electrode assembly can seriously undermine the safety and reliability of rechargeable batteries, and a technological approach is required to effectively resolve this phenomenon.

The above-disclosed information is only to enhance understanding of the background of the described technology, and it may therefore contain information that does not constitute prior art.

### SUMMARY OF THE DISCLOSURE

The present disclosure provides a rechargeable battery with improved stability.

The present disclosure provides a battery pack including the above-described rechargeable battery.

Technical solutions obtainable from the present disclosure are not limited to those described herein and other unmentioned technical solutions will be clearly understood from the following description by those having ordinary skill in the technical field to which the present disclosure pertains.

A rechargeable battery according to an embodiment of the present disclosure includes a case, an electrode assembly accommodated in the case, and a cap assembly coupled to the case, wherein the cap assembly includes a lower cap, a vent plate on the lower cap, a upper cap disposed opposite to the lower cap with the vent plate interposed therebetween, and an insulating disk including a plate adjacent to the lower cap and a leg extending from the first plate toward the electrode assembly, wherein a plurality of openings are formed in the lower cap, with the openings being arranged radially around a center of the lower cap, and wherein the insulating disk is disposed radially inward from the plurality of openings.

The cap assembly may further include a second insulating disk disposed radially outward from the plurality of openings, and the second insulating disk may include a second plate adjacent to the lower cap, and a second leg extending from the second plate toward the electrode assembly.

The first leg may include a reinforcing member, and the reinforcing member may be made of metal material.

The reinforcing member may be made of stainless steel or iron.

The first leg may be thicker than the second leg.

The length of the first leg may be longer than the length of the second leg.

When the difference in expansion height near a center winding portion of the electrode assembly compared to the edge of the electrode assembly is T, the length of the first leg is 0.5T longer than the length of the second leg.

The cap assembly may further include a connecting member connecting the first plate and the second plate.

The connecting member may be disposed between the plurality of openings of the lower cap.

The connecting member may be made of resin.

The first leg may include a reinforcing member inserted therein, and the reinforcing member may be made of metal material.

The second insulating disk may further include an extension disposed between the vent plate and the lower cap, and the extension may be made of the same material as the second plate and the second leg and the extension may be electrically insulating.

a center of the vent plate may be electrically connected to the center of the lower cap.

The rechargeable battery may further include an electrically insulating insulator disposed between an edge of the vent plate and an edge of the lower cap.

An insulating plate may be positioned between the insulating disk and the electrode assembly.

A battery pack according to an embodiment of the present disclosure to solve the technical object includes a housing, and the above-described rechargeable battery accommodated in the housing.

According to the present disclosure, it is possible to prevent expansion or rising of the electrode assembly.

According to the present disclosure, it is possible to prevent electrical short due to deformation of the lower cap.

The effects that may be obtained from the present disclosure art not limited to only the above-described effects, and other effects which are not described herein will become apparent to those skilled in the art from the following description.

### BRIEF DESCRIPTION OF THE DRAWINGS

The accompanying drawings illustrate preferred embodiments of the present disclosure and, together with the foregoing disclosure, serve to provide further understanding of the technical spirit of the present disclosure. But the present disclosure is not limited to the embodiments depicted in the drawings.

FIG. 1 is a perspective view of a rechargeable battery according to a first embodiment of the present disclosure.

FIG. 2 is a cross-sectional view as taken along line II-II of the rechargeable battery of FIG. 1.

FIG. 3 is a cross-sectional view as taken along line III-III of the rechargeable battery of FIG. 1.

FIG. 4 is a bottom view of a cap assembly of the rechargeable battery of FIG. 1.

FIG. 5 is an enlarged view of the V portion of the rechargeable battery of FIG. 2.

FIG. 6 is an enlarged view of the rechargeable battery including the cap assembly according to a second embodiment of the present disclosure.

FIG. 7 is a bottom view of the cap assembly of FIG. 6.

FIG. 8 is an enlarged view of the rechargeable battery including the cap assembly according to a third embodiment of the present disclosure.

FIG. 9 is an enlarged view of the rechargeable battery including the cap assembly according to a fourth embodiment of the present disclosure.

FIG. 10 is a bottom view of the cap assembly of FIG. 9.

FIG. 11 is an enlarged view of the rechargeable battery including the cap assembly according to a fifth embodiment of the present disclosure.

FIG. 12 is an enlarged view of the rechargeable battery including the cap assembly according to a sixth embodiment of the present disclosure.

FIG. 13 is a perspective view of a battery pack including the rechargeable battery according to an embodiment of the present disclosure.

### DETAILED DESCRIPTION OF THE EMBODIMENTS

Hereinafter, preferred embodiments of the present disclosure will be described in detail with reference to the attached drawings. It should be noted that terms and words used in the specification and claims of the present disclosure are not to be construed in their ordinary or dictionary sense, but rather as meanings and concepts conforming to the technical spirit of the present disclosure based on the principle that the inventor may appropriately define the concepts of the terms to explain the present disclosure in the best manner. Accordingly, it is to be understood that the detailed description, which will be disclosed along with the accompanying drawings, is intended to describe the exemplary embodiments of the present invention and is not intended to represent all technical ideas of the present disclosure, and therefore it should be understood that various equivalents and modifications may exist which may replace the embodiments described at the time of the application. It should be further understood that the terms “comprise” and “include” and/or “comprising” and “including,” when used in this specification, specify the presence of stated features, numbers, steps, operations, elements, and/or components, but do not preclude the presence or addition of one or more other features, numbers, steps, operations, elements, components, and/or groups thereof. Additionally, when describing embodiments of the present disclosure, the phrases “may” and “may be” may include “one or more embodiments of the present disclosure.”

In addition, for ease of understanding of the present disclosure, the accompanying drawings are not drawn to actual scale, but the dimensions of some components may be exaggerated. In addition, like reference numbers may be assigned to like components in different embodiments.

Stating herein that two objects of comparison are “the same” means that they are “substantially the same.”

Therefore, substantially identical may include a deviation that is considered low in the art—for example, a deviation of less than 5%. Additionally, uniformity of a parameter in a certain region may mean uniformity from an average perspective.

Although the terms “first,” “second,” and the like are used to explain various components, the components are not limited to such terms. These terms are only used to distinguish one component from another component, and unless explicitly stated to the contrary, the second component may be referred to as the first component.

Throughout the specification, unless otherwise stated, each component may be singular or plural.

It should also be understood that when a first element or layer is referred to as being “on” or “beneath” a second element or layer, the first element may be disposed directly on or beneath the second element or may be disposed indirectly on or beneath the second element with a third element or layer being disposed between the first and second elements or layers.

It should be noted that if it is stated in the specification that one component is “connected” or “coupled” to another component, a third component may be “connected,” “coupled,” and “joined” between the first and second components, although the first component may be directly connected, coupled, or joined to the second component. In addition, when a part is electrically coupled to another part, it includes not only cases where the two parts are directly connected, but also cases where they are connected with another element therebetween.

Reference to “A and/or B” throughout the specification, means A, B, or A and B, unless specifically stated to the contrary. That is, “and/or” includes any or all combinations of the plurality of listed items. Reference to “C through D” means that it is greater than or equal to C and less than or equal to D, unless otherwise specified.

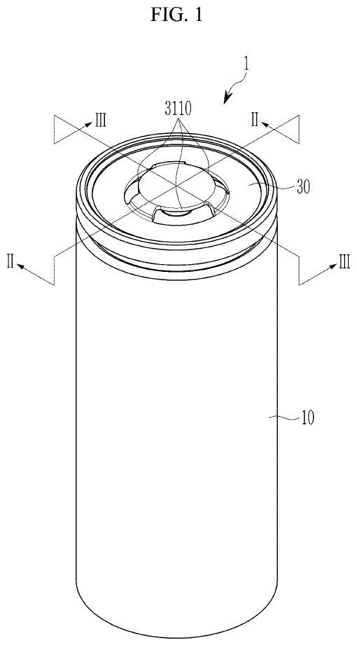

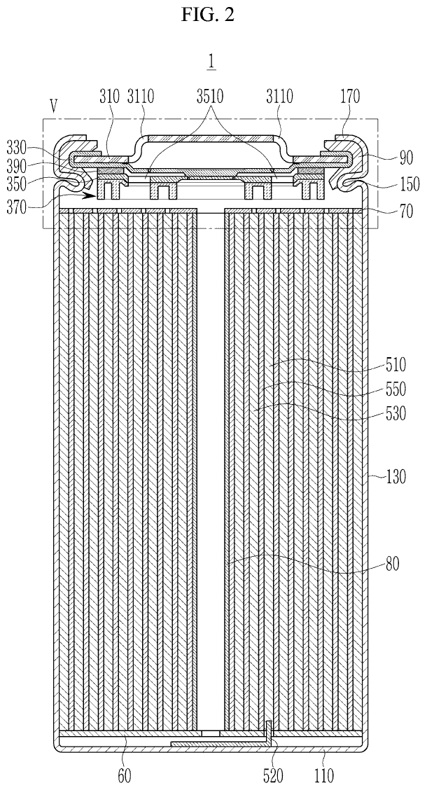

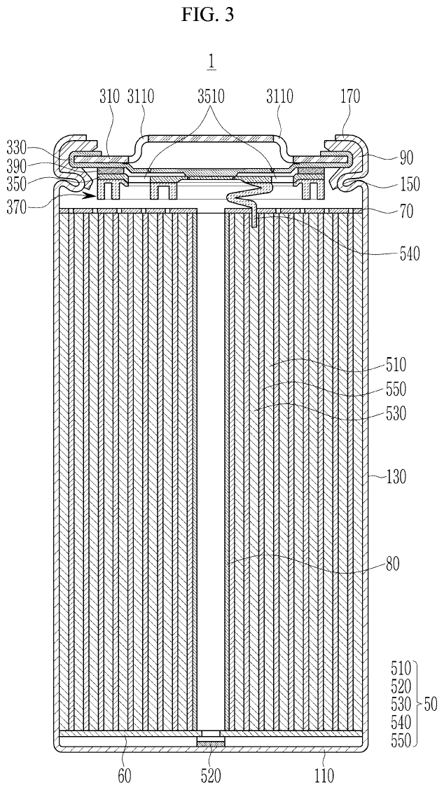

FIG. 1 is a perspective view of a rechargeable battery 1 according to a first embodiment of the present disclosure, and FIGS. 2 and 3 are cross-sectional views cut along lines II-II and III-III of the rechargeable battery 1 of FIG. 1, respectively.

Referring to FIGS. 1 to 3, the rechargeable battery 1 includes a case 10 with one side open, a cap assembly 30 coupled to the open side of the case 10, and an electrode assembly 50 accommodated in the case 10. The electrode assembly 50 disposed inside the case 10 may be isolated from outside of the secondary battery 1 by the coupling of the cap assembly 30 and the case 10.

The case 10 may include a bottom portion 110 and a side portion 130 extending from an edge of the bottom portion 110 in a direction perpendicular to a plane on which the bottom portion 110 is located (upward direction based on FIGS. 1 and 2). That is, the case 10 may have a structure in which only one side facing the bottom portion 110 is open.

The electrode assembly 50 may be accommodated inside the case 10 by being inserted through the open side of the case 10. The case 10 may include a beading portion 150 in which a part of the side portion 130 is recessed inwardly of the case 10. When the electrode assembly 50 is accommodated in the case 10, the distance between the beading portion 150 and the bottom portion 110 of the case 10 may be greater than the height of the electrode assembly 50. The beading portion 150 may prevent movement of the electrode assembly 50 in the length direction (up and down direction depicted in FIG. 2).

The case 10 may further include a crimping portion 170 in which an end of the side portion 130 is bent inwardly of the case 10. The crimping portion 170 may be located further away from the electrode assembly 50 than the beading portion 150. The cap assembly 30 may be affixed by the crimping portion 170.

The cap assembly 30 may be a current interruption device (CID). The cap assembly 30 may include a upper cap 310 (or cap up), a vent plate 330, a lower cap 350 (or cap down), and an insulating disk 370.

The upper cap 310 may be disposed on a first surface of the vent plate 330 and may a plurality of through-holes 3110 may be formed in the upper cap 310. If the vent plate 330 is broken due to a thermal event occurring inside the rechargeable battery 1, gas generated inside the rechargeable battery 1 may be discharged to outside of the rechargeable battery 1 through the through-holes 3110.

One surface of the lower cap 350 may face a second surface of the vent plate 330. For example, the lower cap 350 may be disposed to face the upper cap 310 with the vent plate 330 therebetween. A plurality of openings 3510 may be formed in the lower cap 350, with the openings 3510 being arranged radially around the center of the lower cap 350. The openings 3510 act as passages through which gas generated in the electrode assembly 50 can pass.

The insulating disk 370 may be disposed so as to contact a surface of the lower cap 350. The insulating disk 370 may have a structure that extends in a direction (downward direction as depicted in FIG. 2) toward the electrode assembly 50. The insulating disk 370 may suppress deformation in a direction (upward direction as depicted in FIG. 2) of the electrode assembly 50 wherein the electrode assembly 50 rises toward the cap assembly 30.

The insulating disk 370 may be made of an insulating material and may maintain a gap between the lower cap 350 and the electrode assembly 50. The insulating disk 370 may prevent an electrical short even if deformation of the lower cap 350 occurs (as described above). The insulating disk 370 may be made of one or more plastics such as polyimide (PI), polypropylene (PP), polybutylene terephthalate (PBT), and bakelite. Additionally, the insulating disk 370 may have a rigidity capable of exerting a repulsive force against an expansion force from the electrode assembly 50. A detailed description of the insulating disk 370 will be provided below.

The cap assembly 30 may further include an insulator 390 disposed between the edge of the vent plate 330 and the edge of the lower cap 350. The insulator 390 is made of a non-conductive material to electrically insulate the vent plate 330 and the lower cap 350. For example, the insulator 390 may serve as a safety measure to prevent an electrical short that may occur between the edge of the vent plate 330 and the edge of the lower cap 350 in a situation where gas is released if a thermal event occurs within the rechargeable battery 1 and the lower cap 350 is broken due to the resulting pressure and heat.

When a thermal event occurs, the center of the lower cap 350 may be separated from the edge and rise toward the upper cap 310 while remaining connected to the other surface of the vent plate 330. At this time, the insulator 390 may prevent the vent plate 330 and the lower cap 350 from being electrically connected between the edge of the vent plate 330 and the edge of the lower cap (350).

The vent plate 330, which rises together with the separated lower cap 350, may also be broken due to heat and pressure, causing the center and edges of the vent plate 330 to separate. Even in such an event, the insulation state of the vent plate 330 and the lower cap 350 may be maintained due to the insulator 390. Thus, the insulator 390 may effectively suppress an electrical short caused by a thermal event and serve to ensure the safety of the rechargeable battery 1.

The electrode assembly 50 may include a first electrode 510, a second electrode 530, and a separator 550 disposed between the first and second electrodes 510 and 530. The electrode assembly 50 may be a wound structure with the first electrode 510, the separator 550, and the second electrode 530 sequentially stacked.

Each of the first electrode 510 and the second electrode 530 may be either a positive electrode or a negative electrode, and the first electrode 510 and the second electrode 530 may have different polarities. For example, if the first electrode 510 is the negative electrode, the second electrode 530 may be the positive electrode. In other embodiments, if the first electrode 510 is the positive electrode, the second electrode 530 may be the negative electrode. In the present disclosure, examples will be described where the first electrode 510 is the negative electrode and the second electrode 530 is the positive electrode. But, of course, the present disclosure is not limited to such a configuration.

The positive electrode may include a positive electrode composite layer in which a positive electrode active material (e.g., a transition metal oxide (LiCoO2, LiNiO2, LiMn2O4, etc.)) is coated on a positive electrode current collector plate. The negative electrode may include a negative electrode composite layer in which a negative electrode active material (e.g., graphite, carbon, etc.) is coated on a negative electrode current collector plate. The negative electrode current collector plate may be copper (Cu) foil, and the positive electrode current collector plate may be aluminum (Al) foil. But the materials of each current collector plate are not limited to these examples.

The separator 550 may block contact between the first electrode 510 and the second electrode 530 to prevent an electrical short and only allow the movement of ions (e.g., lithium (Li) ions). The separator 550 may be made of a polyethylene (PE) film, a polypropylene (PP) film, or the like.

The electrode assembly 50 may further include a first electrode tab 520 electrically connected to the first electrode 510 and a second electrode tab 540 electrically connected to the second electrode 530. The first electrode tab 520 may function as a negative electrode tab and may be made of copper (Cu) or nickel (Ni). The second electrode tab 540 may function as a positive tab and may be made of aluminum (Al).

The first electrode tab 520 may protrude from the first electrode 510 in a direction toward the bottom portion 110 of the case 10. The second electrode tab 540 may protrude from the second electrode 530 in a direction toward the cap assembly 30. However, the protrusion direction of the first electrode tab 520 and the second electrode tab 540 is not limited and may be opposite to the directions in the depicted embodiments.

The first electrode tab 520 may be electrically connected to the bottom portion 110 by passing through the first insulating plate 60 disposed between the electrode assembly 50 and the bottom portion 110. Accordingly, the case 10 may have the polarity (e.g., negative electrode) of the first electrode 510.

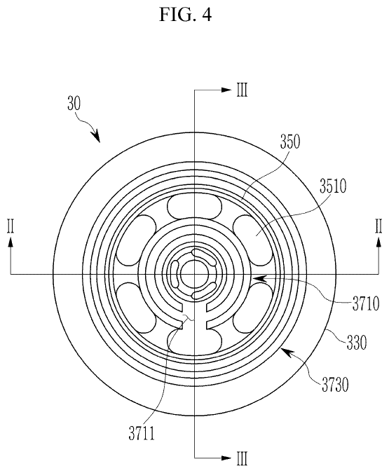

The electrical connection structure of the second electrode tab 540 will be described in detail with reference to FIGS. 3 and 4. FIG. 4 is a bottom view of a cap assembly of the rechargeable battery of FIG. 1.

Referring to FIGS. 3 and 4, the second electrode tab 540 may extend through a second insulating plate 70 that is disposed on the wound electrode assembly 50, may extend through the insulating disk 370, and may be electrically connected to the lower cap 350. A plurality of holes may be formed in the second insulating plate 70 through which the electrolyte and the second electrode tab 540 pass.

The insulating disk 370 may include a first insulating disk 3710 disposed radially inward from the opening 3510 and a second insulating disk 3730 disposed radially outward from the opening 3510.

The second electrode tab 540 extending through the first insulating disk 3710 may be electrically connected to the lower cap 350. In other words, the first insulating disk 3710 may have an opening through which the second electrode tab 540 extends.

Both the first insulating disk 3710 and the second insulating disk 3730 may be a planar circular ring shape. But the first insulating disk 3710 may have a portion removed from the circular ring shape. The removed portion may be defined as a gap 3711 (or opening mentioned above) through which the second electrode tab 540 may be electrically connected to the lower cap 350.

The direction indicated by the line II-II in FIG. 4 may be the same as the direction indicated by the line II-II in FIG. 1, and the direction indicated by the line III-III may be the same as the direction indicated by the line III-III in FIG. 1. As the line II-II in FIG. 1 does not pass through the gap 3711 of the first insulating disk 3710, no electrical connection between the second electrode tab 540 and the lower cap 350 is illustrated in FIG. 2. On the other hand, as the line III-III in FIG. 1 crosses the gap 3711 of the first insulating disk 3710, the electrical connection between the second electrode tab 540 and the lower cap 350 may be seen in FIG. 3.

Referring again to FIG. 2, the rechargeable battery 1 may further include a center pin 80 inside a center winding portion of the electrode assembly 50. The center pin 80 may be a hollow circular pipe and may suppress deformation of the electrode assembly 50 that may occur due to repeated charging and discharging. Additionally, the internal space of the center pin 80 may provide a path through which gas generated inside the rechargeable battery 1 may move.

The rechargeable battery 1 may further include a gasket 90 disposed between the cap assembly 30 and the side portion 130 of the case 10 to block electrical contact between the cap assembly 30 and the case 10. In other words, the gasket 90 may be disposed between the circumference of the vent plate 330 and the circumference of the beading portion 150 and the crimping portion 170 of the case 10. The gasket 90 is made of a non-conductive material and may provide insulation resistance to prevent current from flowing between the cap assembly 30 and the case 10.

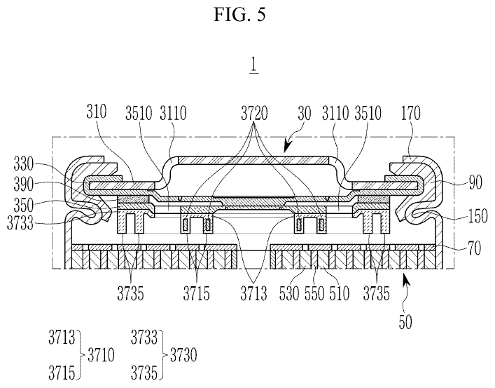

FIG. 5 is an enlarged view of the V portion of the rechargeable battery 1 of FIG. 2, and shows in detail the cap assembly 30 according to the first embodiment of the present disclosure.

Referring to FIG. 5, the cap assembly 30 of the rechargeable battery 1 according to the first embodiment of the present disclosure may include the first insulating disk 3710 disposed between the opening 3510 of the lower cap 350 and a center winding axis of the electrode assembly 50. In other words, the first insulating disk 3710 may be positioned radially inward from the opening 3510 of the lower cap 350.

The first insulating disk 3710 may include a first plate 3713 and a first leg 3715. A first surface of the first plate 3713 may contact the lower cap 350 the first leg 3715 may extend vertically from a second surface of the first plate 3713. The first leg 3715 may be disposed between the electrode assembly 50 and the first plate 3713. In the rechargeable battery 1 according to the first embodiment of the present disclosure, the first plate 3713 has a substantially flat ring shape, and two first legs 3715 may be spaced apart along the circumference of the first plate 3713.

The first leg 3715 of the first insulating disk 3710 may suppress deformation of the electrode assembly 50 in the length direction (upward and downward directions based on FIG. 5). For example, when the electrode assembly 50 expands and the first leg 3715 of the first insulating disk 3710 and the second insulating plate 70 contact each other, the first leg 3715 may press the electrode assembly 50 with a repulsive force against the expansion force of the electrode assembly 50.

In the present disclosure, the expression that the insulating disk 370 presses the electrode assembly 50 includes not only a case where the second insulating plate 70 is disposed on the electrode assembly 50 and the insulating disk 370 indirectly presses the electrode assembly 50 through the second insulating plate 70, but also a case where the second insulating plate 70 is not disposed such that the electrode assembly 50 is directly pressed.

The first insulating disk 3710 may absorb and disperse the expansion force of the electrode assembly 50 by the arrangement and rigidity of the first leg 3715, thereby preventing the electrode assembly 50 from expanding or rising in the direction toward the cap assembly 30 (upward direction based on FIG. 5). With this configuration, the insulating disk 370 may maintain the structural stability of the electrode assembly 50 and prevent an electrical short.

The first insulating disk 3710 of the present disclosure may have a structure that is disposed radially inward from the opening 3510 of the lower cap 350 to contact a region near the center winding portion of the electrode assembly 50 or a region of the second insulating plate 70 disposed on the electrode assembly 50. Accordingly, the first insulating disk 3710 may more effectively suppress expansion (rising) near the center winding portion of the electrode assembly 50.

The cap assembly 30 of the rechargeable battery 1 according to the first embodiment of the present disclosure may further include the second insulating disk 3730 disposed outward from the first insulating disk 3710. The second insulating disk 3730 may be disposed radially outward from the opening 3510 of the lower cap 350, and may include a second plate 3733 having a first surface in contact with the lower cap 350 and a second leg 3735 extending perpendicularly from a second surface of the second plate 3733.

The second insulating disk 3730 may have a similar shape to the first insulating disk 3710. That is, the second plate 3733 be a substantially flat ring shape, and two second legs 3735 may be spaced apart along the circumference of the second plate 3733.

The second insulating disk 3730 may suppress rising of the electrode assembly 50 that occurs at other parts of the electrode assembly 50 when the electrode assembly 50 expands. In particular, the second insulating disk 3730 may contact the electrode assembly 50 or the second insulating plate 70 to suppress the expansion of the electrode assembly 50.

With the configuration of the rechargeable battery 1 as described herein, the battery may maintain structural stability of the electrode assembly 50, thereby reducing or preventing the risk of an electrical short.

The cap assembly 30 described above includes both the first insulating disk 3710 and the second insulating disk 3730, thereby evenly suppressing expansion near the center winding portion of the electrode assembly 50 and in other parts of the electrode assembly 50. Thus, the cap assembly 30 more effectively prevents the electrode assembly 50 from rising as it expands. However, in other embodiments the rechargeable battery 1 of the present disclosure may also be configured such that the insulating disk 370 of the cap assembly 30 includes only the first insulating disk 3710.

The first legs 3715 of the first insulating disk 3710 may include reinforcing members 3720 to more effectively suppress rising of the electrode assembly 50 near the center winding portion of the electrode assembly 50. The reinforcing members 3720 may be made of a more rigid material than the first leg 3715. For example, the reinforcing member 3720 may be made of a metal material such as stainless steal (SUS) or iron (Fe).

The reinforcing member 3720 may improve the rigidity of the first leg 3715 and minimize deformation of the first leg 3715 despite the expansion force of the electrode assembly 50. With this structure, the first leg 3715 may stably resist the expansion force of the electrode assembly 50 and provide consistent repulsive force without deformation. These structural characteristics of the first leg 3715 may contribute to more effectively suppressing the rising phenomenon that occurs near the center winding portion of the electrode assembly 50.

In the first embodiment of the present disclosure, the reinforcing member 3720 may be inserted into the first leg 3715. However, the present disclosure is not limited thereto. In other embodiments, the reinforcing member 3720 may be provided as a member coated or attached to the surface of the first leg 3715.

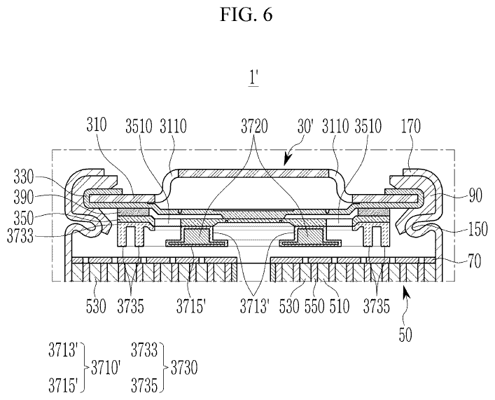

FIGS. 6 to 12 show rechargeable batteries 1′, 1″, 1′″, 1″″, and 1′″″ according to another embodiment of the present disclosure. Parts that are different from the rechargeable battery 1 according to the first embodiment of the present disclosure will be described.

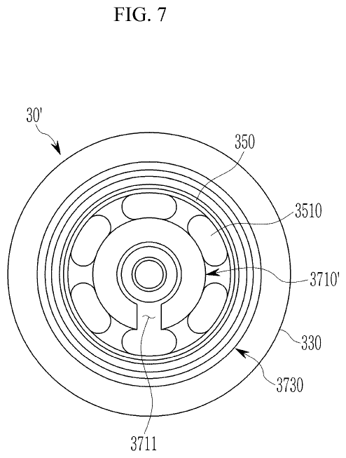

FIG. 6 is an enlarged view of a rechargeable battery 1′ including a cap assembly 30′ according to a second embodiment of the present disclosure, and FIG. 7 is a bottom view of the cap assembly 30′ of FIG. 6. FIG. 6 is comparable to FIG. 5.

Referring to FIGS. 6 and 7, the cap assembly 30′ according to the second embodiment of the present disclosure may include a first insulating disk 3710′ including a first leg 3715′ that is thicker than the second leg 3735 of the second insulating disk 3730. In the examples depicted in FIGS. 6 and 7, the first leg 3715′ including the reinforcing member 3720 has a cross-section with different widths at both ends.

The thickness of the first leg 3715′ may be greater than the thickness of the second leg 3735, thereby providing a wider contact area to the second insulating plate 70 or the electrode assembly 50 than of the contact area of the second leg 3735 to the second insulating plate 70 or the electrode assembly 50. Because of this, when the first insulating disk 3710′ presses the electrode assembly 50 with a repulsive force against the expansion force of the electrode assembly 50, the pressure may be more widely distributed over the center winding portion of the electrode assembly 50. Such an arrangement may prevent excessive stress from being concentrated on a specific region of the electrode assembly 50, thereby minimizing damage to the electrode assembly 50. In addition, as the first insulating disk 3710′ presses the electrode assembly 50 over a wide area, the rising phenomenon occurring near the center winding portion of the electrode assembly 50 may be more effectively suppressed.

The first insulating disk 3710′ is made of a non-conductive material to provide an insulating function while also pressing the expanding electrode assembly 50 over a large area to prevent damage to the electrode assembly 50. Accordingly, in the present embodiment, the rechargeable battery 1′ may not include the second insulating plate 70. The first insulating disk 3710′ also functions to suppress the upward-and-downward movement of the electrode assembly 50, thereby effectively replacing a function of the second insulating plate 70. Thus, according to the present embodiment, the second insulating plate 70 may be omitted from the rechargeable battery 1′, thereby reducing the weight and the manufacturing cost of the rechargeable battery 1′.

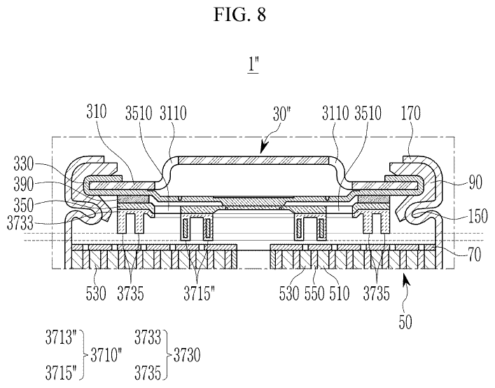

FIG. 8 shows a rechargeable battery 1″ according to a third embodiment of the present disclosure and is an enlarged view of a cap assembly 30″.

Referring to FIG. 8, in the rechargeable battery 1″ according to the third embodiment of the present disclosure, the length of the first leg 3715″ of a first insulating disk 3710″ may be longer than the length of the second leg 3735 of the second insulating disk 3730. Here, “length” refers to a distance in the vertical direction. Because the length of the first leg 3715″ is longer than the length of the second leg 3735, expansion occurring near the center winding portion of the electrode assembly 50 may be effectively suppressed. This may help reduce the problem of relatively greater expansion occurring near the center winding portion than at the edge of the electrode assembly 50.

In more detail, the electrode assembly 50 may expand more near the center winding portion than at the edge. If the difference in distance between before and after expansion of the maximum expansion portion in this region is T, then the first leg 3715″ may have a length that is 0.5T longer than the second leg 3735 to accommodate the additional expansion. This allows the first insulating disk 3710″ to more effectively suppress expansion occurring near the center winding portion of the electrode assembly 50.

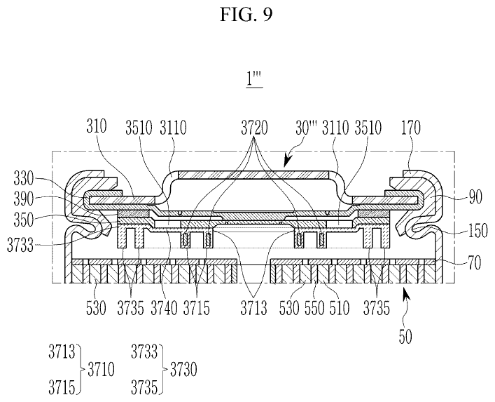

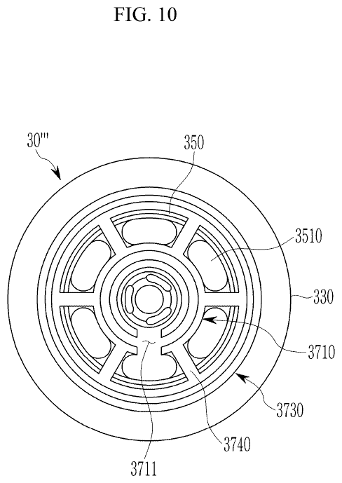

FIG. 9 and FIG. 10 show a rechargeable battery 1′″ according to a fourth embodiment of the present disclosure. FIG. 9 is an enlarged view of the rechargeable battery 1′″ including a cap assembly 30′″ according to the fourth embodiment, and FIG. 10 is a bottom view of the cap assembly 30′″ of FIG. 9.

Referring to FIGS. 9 and 10, the first insulating disk 3710 and the second insulating disk 3730 may be connected to each other. That is, the cap assembly 30 may further include a connecting member 3740 connecting the first insulating disk 3710 and the second insulating disk 3730. The connecting member 3740 may be disposed between the first plate 3713 and the second plate 3733 and between the radially arranged openings 3510 of the lower cap 350. That is, the connecting member 3740 is positioned to not block the openings 3510 while connecting the first insulating disk 3710 and the second insulating disk 3730.

The connecting member 3740 may be made of resin. By connecting the first plate 3713 and the second plate 3733 with the connecting member 3740, the mechanical stability of the first insulating disk 3710 and the second insulating disk 3730 may be increased, and the expansion force of the electrode assembly 50 may be better withstood. With this arrangement, it is possible to more effectively suppress the upward expansion of the electrode assembly 50.

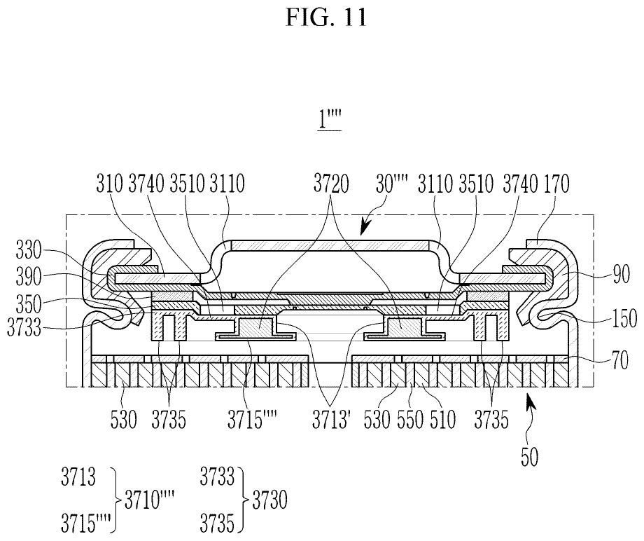

FIG. 11 shows a rechargeable battery 1″″ according to a fifth embodiment of the present disclosure. FIG. 11 is an enlarged view of the rechargeable battery 1″″ including a cap assembly 30″″ according to the fifth embodiment.

Referring to FIG. 11, the insulating disk 370 of the rechargeable battery 1″″ according to the fifth embodiment of the present disclosure may include the connecting member 3740 connecting a first insulating disk 3710″″ and the second insulating disk 3730, and the first insulating disk 3710″″ may include a first leg 3715″″ that is thicker than the second leg 3735.

Since the first leg 3715″″ has a large contact area, when the first insulating disk 3710 presses the electrode assembly 50 with a repulsive force against the expansion force of the electrode assembly 50, the force may be more widely distributed, thereby reducing damage to the electrode assembly 50. In addition, by pressing the electrode assembly 50 over a wider area, the rising phenomenon occurring near the center winding portion of the electrode assembly 50 may be more effectively suppressed. In addition, the first plate 3713 and the second plate 3733 are connected to each other so that the mechanical stability of the first insulating disk 3710″″ may be increased, and the expansion force of the electrode assembly 50 that the first insulating disk 3710″″ can withstand may be increased. Accordingly, the first insulating disk 3710″″ may more effectively suppress the rising near the center winding portion of the electrode assembly 50.

In addition, in the present embodiment, the rechargeable battery 1″″ may not include the second insulating plate 70. That is, according to the present embodiment, the second insulating plate 70 may be omitted from the rechargeable battery 1″″, thereby reducing the weight and the manufacturing cost thereof.

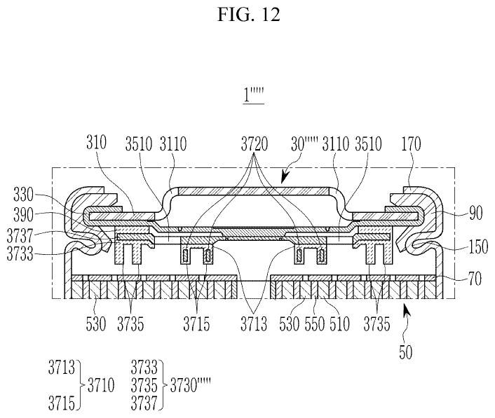

FIG. 12 shows a rechargeable battery 1′″″ according to a sixth embodiment of the present disclosure. FIG. 12 is an enlarged view of the rechargeable battery 1′″″ including the cap assembly 30 according to the sixth embodiment.

In the present embodiment, a second insulating disk 3730′″″ may include an extension 3737 disposed between the vent plate 330 and the lower cap 350. One side of the extension 3737 may be connected to the second plate 3733 and the second leg 3735. The extension 3737 may be made of the same material as the second plate 3733 and the second leg 3735 to provide insulation between the vent plate 330 and the lower cap 350. That is, in the present embodiment, the extension 3737 may replace the insulator (390 in FIG. 5). In other words, in the present embodiment the second insulating disk 3730′″″ may be provided integrally with the insulator 390.

When the second insulating disk 3730′″″ is provided integrally with the insulator 390, the manufacturing process of the cap assembly 30′′ may be facilitated, and the adhesive strength between the second insulating disk 3730′″″ and the lower cap 350 may be increased. In addition, the mechanical stability of the second insulating disk 3730′″″ is increased so that the rising of the electrode assembly 50 may be more effectively suppressed.

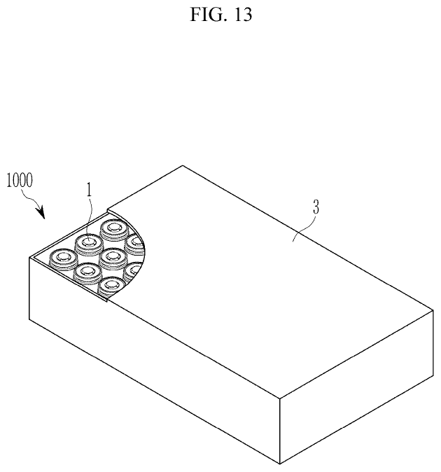

FIG. 13 is a perspective view of a battery pack 1000 including the rechargeable battery 1 according to embodiments of the present disclosure. In FIG. 13, parts of the battery pack 1000 such as a bus bar, a cooling unit, and an external terminal for electrical connection of the rechargeable battery 1 are omitted.

The battery pack 1000 may include a housing 3 and a plurality of rechargeable batteries 1 accommodated in the housing 3.

While the embodiments of the present disclosure have been described in detail, it is to be understood that the disclosure is not limited to the disclosed embodiments. Rather, the present disclosure covers various modifications and equivalent arrangements.

### Description of Symbols

1: Rechargeable battery 3: Housing
10: Case 30: Cap assembly
50: Electrode assembly 60: First insulating plate
70: Second insulating plate 80: Center pin
90: Gasket 110: Bottom portion
130: Side portion 150: Beading portion
170: Crimping portion 310: Upper cap
330: Vent plate 350: Lower cap
370: Insulating disk 390: Insulator
510: First electrode 520: First electrode tab
530: Second electrode 540: Second electrode tab
3110: Through-hole 3510: Opening
3710, 3710′, 3710″, 3710′″, 3710″″: First insulating disk
3711: Gap 3713: First plate
3715: First leg 3720: Reinforcing member
3730, 3730′″″: Second insulating disk
3733: Second plate 3735: Second leg
3737: Extension 3740: Connecting member

What is claimed is:

1. A rechargeable battery, comprising:
a case;
an electrode assembly accommodated in the case; and
a cap assembly coupled to the case,
wherein the cap assembly comprises:
a lower cap;
a vent plate on the lower cap;
an upper cap disposed opposite to the lower cap with the vent plate interposed therebetween; and
an insulating disk comprising a plate adjacent to the lower cap and a leg extending from the plate toward the electrode assembly,
wherein a plurality of openings are formed in the lower cap, with the openings be positioned radially around a center of the lower cap, and
wherein the insulating disk is disposed radially inward from the plurality of openings.

2. The rechargeable battery as claimed in claim 1, wherein the insulating disk is a first insulating disk, the plate is a first plate, and the leg is a first leg, and
wherein the cap assembly further comprises a second insulating disk disposed radially outward from the plurality of openings, and
wherein the second insulating disk comprises:
a second plate adjacent to the lower cap; and
a second leg extending from the second plate toward the electrode assembly.

3. The rechargeable battery as claimed in claim 2, wherein the first leg comprises a reinforcing member, and the reinforcing member is made of metal material.

4. The rechargeable battery as claimed in claim 3, wherein the reinforcing member is made of stainless steel or iron.

5. The rechargeable battery as claimed in claim 4, wherein the first leg is thicker than the second leg.

6. The rechargeable battery as claimed in claim 2, wherein a length of the first leg is longer than a length of the second leg.

7. The rechargeable battery as claimed in claim 6, when a difference in expansion height near a center winding portion of the electrode assembly compared to an edge of the electrode assembly is T, the length of the first leg is 0.5T longer than the length of the second leg.

8. The rechargeable battery as claimed in claim 2, wherein the cap assembly further comprises a connecting member connecting the first plate and the second plate.

9. The rechargeable battery as claimed in claim 8, wherein the connecting member is disposed between the plurality of openings of the lower cap.

10. The rechargeable battery as claimed in claim 9, wherein the connecting member is made of resin.

11. The rechargeable battery as claimed in claim 10, wherein the first leg comprises a reinforcing member inserted therein, and the reinforcing member is made of metal.

12. The rechargeable battery as claimed in claim 2, wherein the second insulating disk further comprises an extension disposed between the vent plate and the lower cap, and
wherein the extension is made of the same material as the second plate and the second leg, and the extension is electrically insulating.

13. The rechargeable battery as claimed in claim 1, wherein a center of the vent plate is electrically connected to the center of the lower cap.

14. The rechargeable battery as claimed in claim 13, further comprising an electrically insulating insulator disposed between an edge of the vent plate and an edge of the lower cap.

15. The rechargeable battery as claim in claim 1, further comprising an insulating plate positioned between the insulating disk and the electrode assembly.

16. A battery pack, comprising:
a housing; and
the rechargeable battery as claimed in claim 1 accommodated in the housing.
